(19) United States
(12) Patent Application Publication
(10) Pub. No.: US 2018/0005145 A1
(43) Pub. Date: Jan. 4, 2018

(54) MITIGATING SURGE PRICING IN RIDESHARING SERVICES

(71) Applicant: RideSage Inc., Emeryville, CA (US)

(72) Inventors: Paul Lo, San Jose, CA (US); Andrew Tsukahira, Los Angeles, CA (US); Henry Vogel, Saratoga, CA (US)

(73) Assignee: RideSage Inc., Emeryville, CA (US)

(21) Appl. No.: 15/624,132

(22) Filed: Jun. 15, 2017

Related U.S. Application Data
(60) Provisional application No. 62/357,450, filed on Jul. 1, 2016.
(60) Provisional application No. 62/356,009, filed on Jun. 29, 2016.

(51) Int. Cl. G06Q 10/02; G06Q 10/04; G06Q 30/02; G06Q 50/30

(52) U.S. Cl. CPC G06Q 10/025; G06Q 50/30; G06Q 10/047; G06Q 30/0284

(57) ABSTRACT

Some embodiments are directed to a server component providing to a client device information which a traveler may use to determine when various ridesharing services have surge pricing in effect for a ride, enabling the traveler to mitigate the effect of surge pricing on the price of the ride. Some embodiments are directed to a server component causing one or more ridesharing services to be passively monitored, and automatically notifying a traveler when surge pricing for a ride is discontinued, so that a traveler need not check and re-check with the ridesharing service(s).

### RELATED APPLICATIONS

This application claims priority under 35 U.S.C. §119(e) to U.S. Provisional Patent Application Ser. No. 62/356,009, entitled “Mitigating Surge Pricing In Ridesharing Services,” filed Jun. 29, 2016, bearing Attorney Docket No. B1453.70003US00, and to U.S. Provisional Patent Application Ser. No. 62/357,450, entitled “Mitigating Surge Pricing In Ridesharing Services,” filed Jul. 1, 2016, bearing Attorney Docket No. B1453.70004US00. The entirety of each of the documents listed above is incorporated herein by reference.

### BACKGROUND

Surge pricing (also referred to as dynamic pricing or demand pricing) is a pricing strategy in which businesses set flexible prices for products or services based on such factors as current market supply and demand for the products or services, and the pricing for the products or services that is offered by competitors.

Ridesharing services sometimes use surge pricing to determine the price that a traveler will pay for a particular ride. That is, ridesharing services commonly employ algorithms to determine when surge pricing is to go into effect for rides originating from a certain area, and the price for each ride originating from that area. The price, which is commonly determined by applying a multiplier to a “base” price for the ride, is typically based at least in part on supply (i.e., the number of drivers around the area who are available to pick up travelers) and demand (i.e., the number of travelers trying to reserve a ride from the area). Surge pricing affects different ridesharing services in different ways, at different times, for different areas. For example, surge pricing may be in effect for one ridesharing service for rides originating from an area but not for other ridesharing services offering rides from the same area, and a particular ridesharing service may have surge pricing in effect for rides originating from one area but not from other areas.

### SUMMARY

Users of ridesharing services often find it difficult to determine and predict which ridesharing services have surge pricing in effect for rides originating from which areas. Users are often forced to check and re-check with various different individual ridesharing services to determine whether surge pricing is in effect for those services, and if so, how surge pricing affects the price the user will pay for a particular ride.

Some embodiments of the invention are directed to providing a centralized source of information which a user may employ to determine when various ridesharing services have surge pricing in effect for a ride originating from a particular area. This centralized source of information may allow the user to mitigate the effect of surge pricing on the price of the ride. For example, when a user attempts to reserve a ride, some embodiments may present an interface which shows whether each of a plurality of ridesharing service options have surge pricing in effect for the ride, and how any surge pricing may affect the price that the user may pay for the ride. Based on this information, the user may make informed decisions on which ridesharing service to choose. For example, the user may choose a ridesharing service that does not then have surge pricing in effect, such as the service that offers the lowest price for the ride. Or, if the user prefers to use one ridesharing service rather than others, but that service then has surge pricing in effect, the user may opt to wait until that ridesharing service discontinues surge pricing. In this respect, some embodiments of the invention enable a user to passively monitor a particular ridesharing service and be notified automatically when the service has discontinued surge pricing.

As a result, users may determine whether and how surge pricing may affect the price of a ride without having to check and re-check with each of various ridesharing services over time. Moreover, instead of manually checking and re-checking with various ridesharing services over time while attempting to do other things, by passively monitoring whether surge pricing remains in effect and automatically notifying the user as soon as it has been discontinued, some embodiments of the invention enable the user to be notified more quickly than conventional approaches allow, therefore allowing the user to complete the ride more quickly.

The foregoing is a non-limiting summary of only certain aspects of the invention, some embodiments of which are described in the sections that follow.

### BRIEF DESCRIPTION OF DRAWINGS

The accompanying drawings are not intended to be drawn to scale. In the drawings, each identical or nearly identical component illustrated in the various figures is represented by a like numeral. For purposes of clarity, not every component may be labeled in every drawing. In the drawings:

FIG. 1 is a flow chart for a representative process for enabling a user to mitigate the effect of surge pricing on a particular ride from a ridesharing service, in accordance with some embodiments of the invention;

FIGS. 2-6 depict representative screen interfaces providing access to functionality for mitigating the effect of surge pricing on a ride from a ridesharing service, in accordance with some embodiments of the invention;

FIG. 7 is a block diagram depicting a representative system architecture for providing functionality relating to enabling travelers to manage transportation options, in accordance with some embodiments of the invention; and

FIG. 8 is a block diagram depicting a representative computer system which may be used to implement certain aspects of the invention.

### DETAILED DESCRIPTION

Some embodiments of the invention provide a centralized source of information which a user may employ to determine when various ridesharing services have surge pricing in effect for a particular ride. For example, when a user attempts to reserve a ride, some embodiments may present an interface which shows the user whether each of a plurality of ridesharing service options then have surge pricing in effect for the ride, and how surge pricing may affect the price for the ride. Based on this information, the user may, for example, choose a ridesharing service that does not then have surge pricing in effect, such as a service which offers the lowest price for the ride. Some embodiments may also, or additionally, enable the user to mitigate the effect of surge pricing on the price for a particular ride. For example, some embodiments enable a user to passively monitor a ridesharing service, and be notified automatically when the service discontinues surge pricing for a ride. As a result, users need not check and re-check with each of various ridesharing services over time to determine whether and how surge pricing affects the price of a ride.

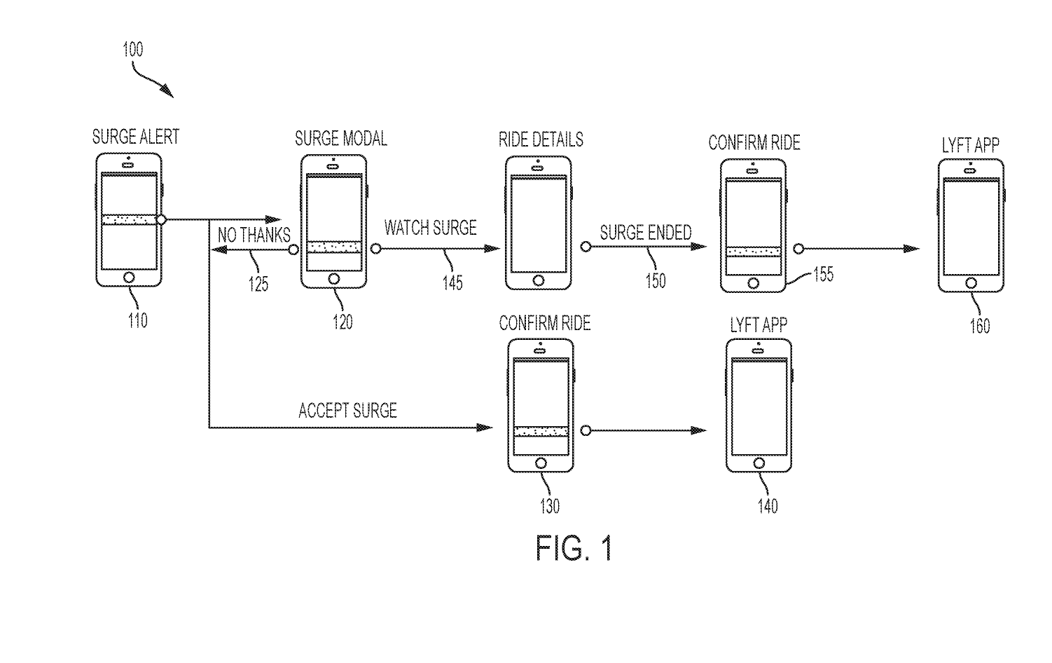

FIG. 1 depicts a representative process 100 for enabling a user to avoid and/or mitigate the effect of surge pricing on the price of a particular ride. As FIG. 1 indicates, representative process 100 may involve interaction between a traveler and a mobile device. Any suitable mobile device may be used, such as a smartphone, tablet, personal (e.g., laptop) computer, smartwatch, gaming console, and/or any other suitable mobile device(s), whether now known or later developed. In some embodiments, the mobile device may execute one or more apps, applications and/or other computing components. It should be appreciated that, in some embodiments, the component(s) executing on the mobile device may communicate via one or more networks (not shown) with one or more remote components executing on one or more remote servers (also not shown). As a result, representative process 100 may involve interaction between the computing component(s) executing on the mobile device and the remote computing component(s) over the network(s) to provide the functionality described herein. It should also be appreciated that this functionality may be distributed, logically and/or physically, in any suitable manner across the component(s) executing on the mobile device and the remote component(s) executing on the remote server(s). The invention is not limited to any particular mode of implementation.

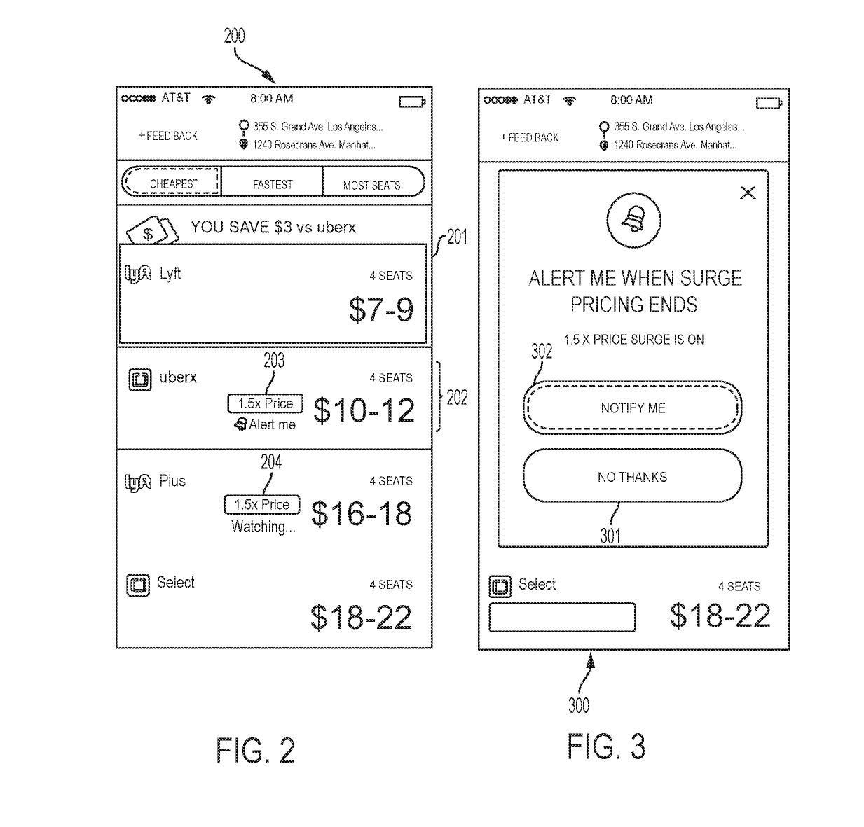

At the start of representative process 100, a user is alerted that surge pricing is in effect for one or more ride sharing services at 110, such as in response to attempting to reserve a ride. In some embodiments, the alert may also indicate how surge pricing imposed by any ridesharing service(s) affects the price of the ride, such as by indicating any price multiplier which is applied by a ridesharing service, and the price for the ride as a result of applying the multiplier. For example, FIG. 2 depicts a representative screen interface 200 for notifying a user that surge pricing is in effect for certain ridesharing services. In the example shown in FIG. 2, representative screen interface 200 displays four ridesharing service options (i.e., for Lyft, UberX, Lyft Plus and Uber Select), indicates that surge pricing is in effect via the indication of price multipliers of 1.5 for the UberX and Lyft Plus ridesharing services at 203 and 204, respectively. Representative screen interface 200 indicates the anticipated price for the ride from each ridesharing service shown.

Although not shown in FIG. 2, some embodiments of the invention may indicate, for ridesharing services with surge pricing then in effect for a ride, what the price would be with and without surge pricing in effect, so that the user can readily see what savings are possible by waiting until surge pricing is discontinued. In this respect, the Assignee has appreciated that different users may have different sensitivities to surge pricing, and that a particular user's sensitivity may depend on his/her circumstances. For example, a business traveler with a tight schedule, a five dollar difference in the price of a ride with surge pricing in effect may not be enough to deter him/her from accepting a ride. However, for a budget-conscious student with plenty of time, a five dollar difference may warrant waiting until surge pricing is discontinued.

Representative screen interface 200 also enables the user to automatically monitor the surge pricing imposed by ridesharing services. For example, if the user provides input at 205 to select the UberX ridesharing service (which, in this example, has surge pricing in effect) to provide the ride, then representative process 100 (FIG. 1) proceeds to 120, wherein a surge modal is presented to the user to determine whether the user would like to automatically monitor the ridesharing service to determine when surge pricing is discontinued. A representative screen interface 300 providing a user with this option is shown in FIG. 3. Representative screen interface 300 allows the user to indicate that he/she is to be notified when surge pricing is no longer in effect (by providing input to button 302), or to indicate that no surge pricing monitoring is to be performed (by providing input to button 301).

If the user indicates that no monitoring of surge pricing is to be performed by providing input to button 301, then representative process 100 (FIG. 1) proceeds via 125 to 130, wherein the user confirms the selection of the ride and ridesharing service. A representative screen interface 600 for confirming a ride is shown in FIG. 6. In the example shown, the user confirms the selected ride by providing input to button 601. Of course, any suitable mechanism for confirming a ride may alternatively be provided. In the example shown, providing input to button 601 causes a corresponding ridesharing service app to be opened on the user's mobile device so that the selected ride may be booked.

If the user indicates that he/she is to be notified when surge pricing is discontinued by providing input to button 302, then representative process 100 (FIG. 1) proceeds to 145, wherein the surge pricing imposed by the ridesharing service is automatically monitored. Monitoring may be performed in any of numerous ways. In some embodiments of the invention, one or more automated processes may periodically (e.g., every five seconds, and/or at any other suitable fixed or non-fixed interval) communicate with a ridesharing service (e.g., an API, web service or other component(s) made available by the ridesharing service) to determine whether surge pricing remains in effect. These automated processes may execute on any suitable device(s). For example, in some embodiments, these process(es) may execute on a user's mobile device, and cause the mobile device to communicate periodically with remote components (e.g., executing on one or more remote servers). Of course, automatic monitoring may be implemented in any of numerous ways, and any suitable component(s) executing on any suitable device(s) may automatically monitor a ridesharing service to determine whether surge pricing remains in effect, in any suitable way. The invention is not limited to any particular mode of implementation.

If a user's device is employed to automatically monitor surge pricing, some embodiments may employ measures to conserve battery usage by the device. For example, some embodiments may limit a user to only monitoring one ride and ridesharing service at a time, so as to limit the amount of energy used in ridesharing service communications.

Representative process 100 (FIG. 1) then proceeds to 150, wherein a determination is made that surge pricing has been discontinued for the ride. For example, automated processes executing on the user's mobile device may receive a notification from one or more remotely executing processes indicating that surge pricing for the ride has ended.

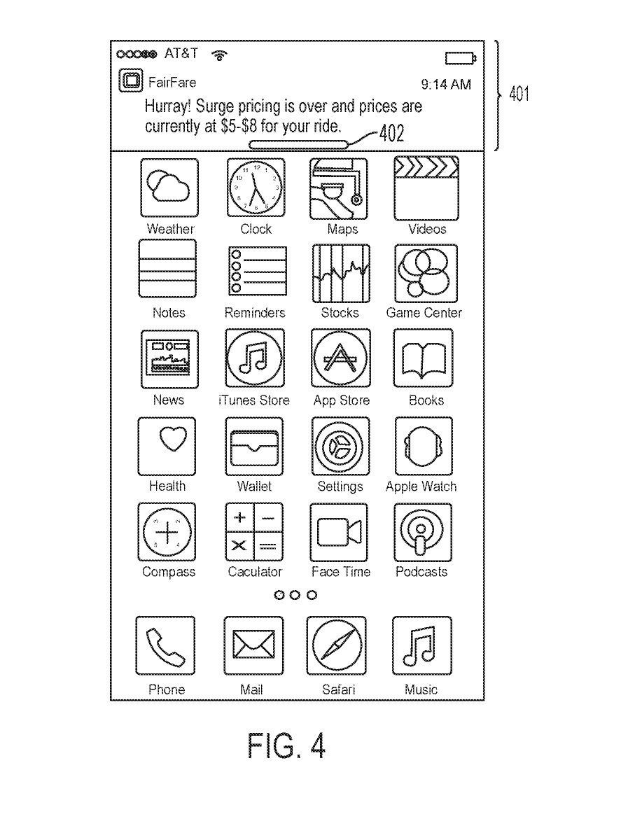

A user may be notified that surge pricing has been discontinued in any of numerous ways. For example, the user's mobile device may automatically display a notification when it is received. A representative notification 401, which those skilled in the art will recognize as a banner notification, is shown in FIG. 4. In this respect, the Assignee has appreciated that after requesting that surge pricing be automatically monitored, some users may move on to other tasks, and may close the app in which representative screen interface 300 is displayed. As such, some embodiments provide for a banner notification to be displayed to notify the user that surge pricing has been discontinued, since a banner notification may be displayed regardless of any app (or no app) being used when it is determined that surge pricing has ended. FIG. 4 shows banner notification being displayed on the home screen of the user's mobile device, although a banner notification may be shown within another app if one is then open. Of course, the invention is not limited to employing a banner notification, as any suitable technique for notifying a user that surge pricing has been discontinued may alternatively, or additionally, be used.

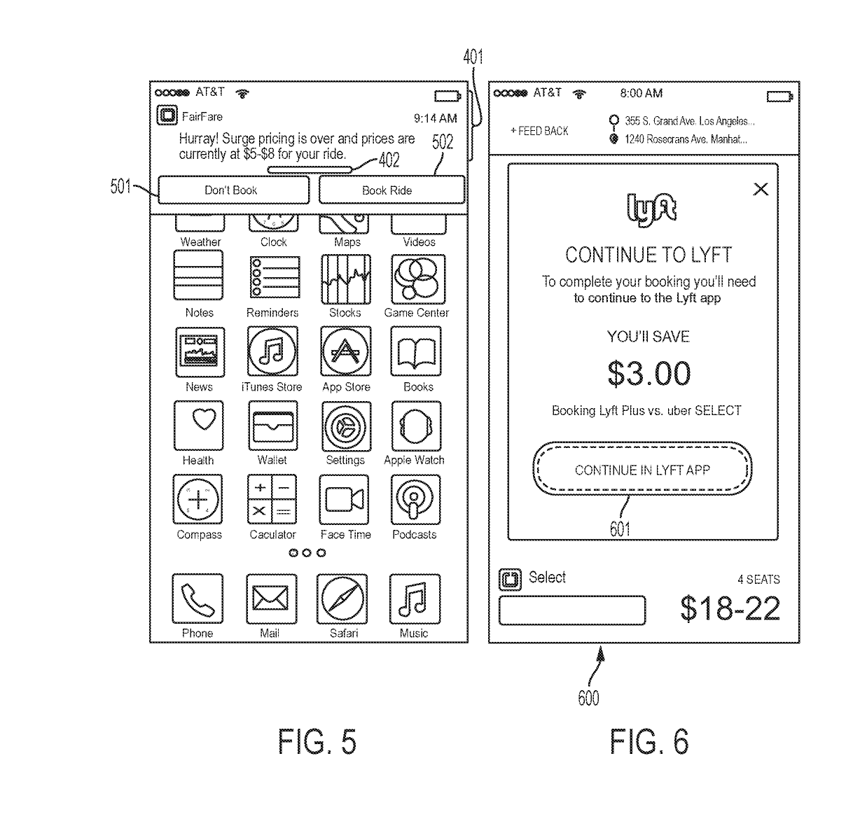

In some embodiments of the invention, a banner notification displayed to a user may be interactive. For example, FIG. 5 depicts banner notification 401 having been expanded in response to the user dragging bar 402, to reveal the additional options “don't book” 501 and “book ride” 502. An interactive banner notification may provide access to any suitable options and/or functionality, which may or may not include functionality relating to booking a ride, in response to any suitable user input.

Representative process 100 (FIG. 1) then proceeds to 155, wherein the user confirms details for the ride without surge pricing in effect. This may be performed in any of numerous ways. For example, the user may provide input to the banner notification shown in FIG. 4 to cause modal 600 shown in FIG. 6 to be presented, and then provide input to button 601. As another example, the user may provide input to the banner notification shown in FIG. 5 at 502, thereby causing modal 600 to appear, and then provide input to button 601. Any of numerous techniques may be used. As discussed above, in some embodiments, a user may proceed to a ridesharing service app to book a confirmed ride. This is also shown in FIG. 1 at 160. Representative process 100 then completes.

It should be appreciated that numerous variations on representative process 100 are possible. For example, in some variations, the acts described with reference to FIG. 1 may be performed in a different sequence than that which is described above. Other variations may include additional acts not described above, and/or may not include all of the acts which are described above.

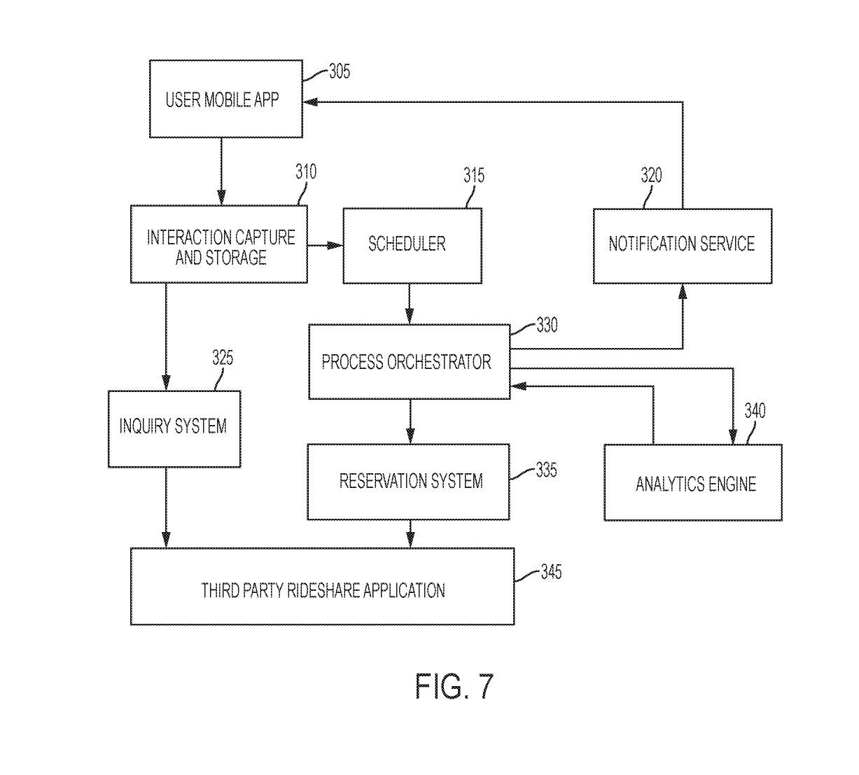

As noted above, in some embodiments of the invention, one or more computing components executing on a traveler's mobile device may communicate with one or more components executing on one or more remote computing devices, such as one or more server computers. In some embodiments of the invention, the component(s) executing on the remote computing device(s) may exchange information with a third-party rideshare application, such as which may be made available by a ridesharing service. FIG. 7 depicts a representative architecture for components which provide functionality of the type described above.

In the architecture shown in FIG. 7, interaction capture and storage module 310 receives information from user mobile app 305, such as input provided by a traveler to the app to specify the details of a ride. Interaction capture and storage module 310 provides information relating to a ride to be scheduled to scheduler module 315, which may, in some embodiments, determine details about a scheduled trip based on other information about the trip provided by the user.

Process orchestrator module 330 receives information on scheduled trips from schedule module 315, and orchestrates communication amongst other modules to keep the traveler informed as to the trip, and to communicate with a third party rideshare application to reserve the trip. For example, process orchestrator module 330 may communicate information via reservation system module 335 to third-party rideshare application 345, and communicate information via notification service module 320 to the user mobile app 305 employed by a traveler. As such, process orchestrator module 330 may interact with user mobile app 305 to provide any or all of the functionality described above with reference to FIG. 1, and communicate any changes to pre-arranged rides to third-party rideshare application 345 so that information may then be conveyed to one or more ridesharing service drivers.

In the representative architecture shown in FIG. 3, process orchestrator module 330 may provide information on rides to analytics engine 340 to glean insights from such information. For example, analytics engine 340 may process feedback received from travelers on completed rides, delays to rides, etc. to cause process orchestrator 330 to modify the manner in which travelers are notified of upcoming trips. Analytics engine 340 may also process traveler feedback received on the user mobile app 305, and this feedback may be employed in any various ways to modify the information which is presented to travelers via the third-party rideshare app by providing such information to process orchestrator 330.

Interaction capture and storage module 310 also provides information received from user mobile app 305 to inquiry system 325, which communicates with third party rideshare application 345 to determine whether travelers have the existing accounts with the third party ride share application. For example, if a user of the mobile app 305 indicates that he/she has an existing account with a third party ride share application, such indication may be provided to interaction capture and storage module 310, which may inquire via inquiry system 325 with third party ride share application 345 to verify the traveler's account with the application.

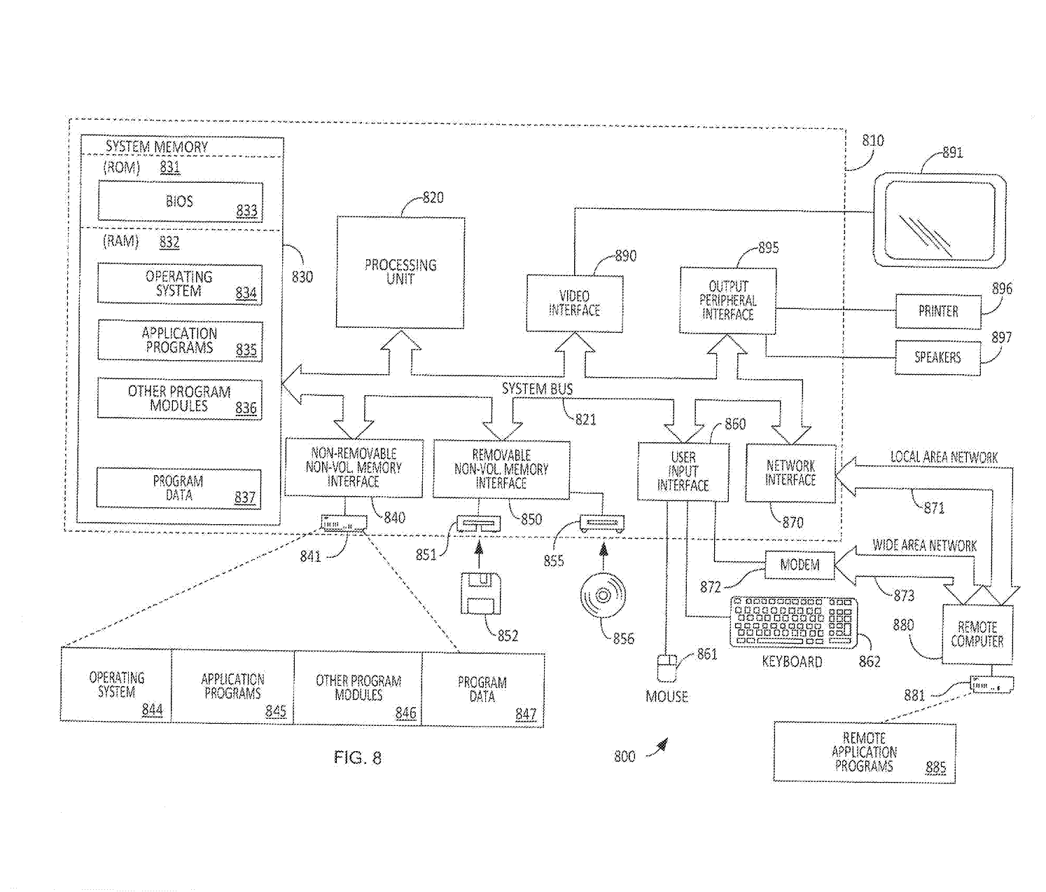

It should be appreciated from the foregoing that some aspects of the invention may be implemented via a computing system. FIG. 8 illustrates one example of a suitable computing system 800 which may be used to implement certain aspects of the invention. The computing system 800 is only one example of a suitable computing system, and is not intended to suggest any limitation as to the scope of use or functionality of the invention. Neither should the computing system 800 be interpreted as having any dependency or requirement relating to any one or combination of components illustrated in the exemplary computing system 800. In this respect, embodiments of the invention are operational with numerous other general purpose or special purpose computing systems or configurations. Examples of well-known computing systems and/or configurations that may be suitable for use with the invention include, but are not limited to, personal computers, server computers, mobile or laptop devices, multiprocessor systems, microprocessor-based systems, set top boxes, programmable consumer electronics, network PCs, minicomputers, mainframe computers, distributed computing systems that include any of the above systems or devices, and the like.

The computing system may execute computer-executable instructions, such as program modules. Generally, program modules include routines, programs, objects, components, data structures, etc. that perform particular tasks or implement particular abstract data types. The invention may also be practiced in distributed computing systems where tasks are performed by remote processing devices that are linked through a communications network. In a distributed computing system, program modules may be located in both local and remote computer storage media including memory storage devices.

FIG. 8 depicts a general purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other one or more media which may be used to store the desired information and may be accessed by computer 810. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary computing system include, but are not limited to, magnetic tape cassettes, flash memory cards, digital versatile disks, digital video tape, solid state RAM, solid state ROM, and the like. The hard disk drive 841 is typically connected to the system bus 821 through an non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies. A user may enter commands and information into the computer 810 through input devices such as a keyboard 862 and pointing device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. In addition to the monitor, computers may also include other peripheral output devices such as speakers 897 and printer 896, which may be connected through a output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on memory device 881. It will be appreciated that the network connections shown are exemplary and other means of establishing a communications link between the computers may be used.

Embodiments of the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a tangible machine, mechanism or device from which a computer may read information. Alternatively or additionally, the invention may be embodied as a computer readable medium other than a computer-readable storage medium. Examples of computer readable media which are not computer readable storage media include transitory media, like propagating signals.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The invention may be embodied as a method, of which an example has been described. The acts performed as part of the method may be ordered in any suitable way. Accordingly, embodiments may be constructed in which acts are performed in an order different than illustrated, which may include different acts than those which are described, and/or which may involve performing some acts simultaneously, even though the acts are shown as being performed sequentially in the embodiments specifically described above.

Use of ordinal terms such as “first,” “second,” “third,” etc., to modify an element does not by itself connote any priority, precedence, or order of one element over another or the temporal order in which acts of a method are performed, but are used merely as labels to distinguish one element having a certain name from another element having a same name (but for use of the ordinal term) to distinguish the elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A computing system, comprising:
at least one server component, coupled to at least one communications network, the at least one server component being programmed to:
receive a request for a ride via the at least one communications network, from a client device associated with a traveler;
in response to receiving the request, identify one or more candidate ridesharing services to provide the ride;
determine whether each of the one or more candidate ridesharing services then has surge pricing in effect for the ride;
in response to determining that at least one candidate ridesharing service then has surge pricing in effect for the ride, send to the client device via the at least one communications network an indication that the at least one candidate ridesharing service then has surge pricing in effect for the ride;
receive from the client device via the at least one communications network a selection of a candidate ridesharing service from the at least one candidate ridesharing service to provide the ride; and
send a request for the ride via the at least one communications network to the selected ridesharing service.

2. The computing system of claim 1, wherein the at least one server component is programmed to send to the client device, in response to determining that at least one candidate ridesharing service then has surge pricing in effect for the ride, a price for the ride with surge pricing in effect, and a price for the ride without surge pricing in effect, for each at least one candidate ridesharing service.

3. The computing system of claim 2, wherein the at least one server component is programmed to receive, from the client device, a selection of a particular candidate ridesharing service to provide the ride, after the particular candidate ridesharing service discontinues surge pricing for the ride.

4. The computing system of claim 1, wherein the at least one server component is programmed to:
in response to determining that at least one candidate ridesharing service then has surge pricing in effect for the ride, periodically communicate with each at least one candidate ridesharing services via the at least one communications network to determine when each at least one candidate ridesharing service discontinues surge pricing for the ride; and
send an indication to the client device upon determining that any of the at least one candidate ridesharing service discontinues surge pricing for the ride.

5. The computing system of claim 1, further comprising one or more of the at least one communications network and the client device.

6. A computing system, comprising:
at least one server component, coupled to at least one communications network, the at least one server component being programmed to:
receive a request, for a ride, via the at least one communications network, from a client device associated with a traveler;
in response to receiving the request, identify a plurality of candidate ridesharing services for the ride, and determine whether each of the plurality of candidate ridesharing services then has surge pricing in effect for the ride;
in response to determining that at least one candidate ridesharing service then has surge pricing in effect for the ride, cause each at least one candidate ridesharing service to be periodically queried to determine when each at least one candidate ridesharing service discontinues surge pricing for the ride;
send to the client device, via the at least one communications network, an indication that a particular candidate ridesharing service has discontinued surge pricing for the ride; and
send a request for the ride via the at least one communications network to the particular candidate ridesharing service.

7. The computing system of claim 6, wherein the at least one server component is programmed to cause each at least one candidate ridesharing service to be periodically queried by causing the client device to periodically communicate with each at least one candidate ridesharing service.

8. The computing system of claim 7, wherein the at least one server component is programmed to cause the client device to periodically communicate with only one candidate ridesharing service at a time.

9. The computing system of claim 6, wherein the at least one server component is programmed to cause the client device to automatically display a message to the traveler in response to determining that a candidate ridesharing service has discontinued surge pricing for the ride.

10. The computing system of claim 6, comprising one or more of the at least one communications network and the client device.
